(19) United States
(12) Patent Application Publication
(10) Pub. No.: US 2026/0127641 A1
(43) Pub. Date: May 7, 2026

(54) RECOMMENDATION METHOD AND SYSTEM BASED ON META DATA AUGMENTATION

(71) Applicant: Sichuan Institute of Artificial Intelligence, Yibin, Sichuan, China, Yibin (CN)

(72) Inventors: Hui XU, Yibin (CN); Changyu LI, Yibin (CN); Yan ZHANG, Yibin (CN); Jie SHAO, Yibin (CN)

(73) Assignee: Sichuan Institute of Artificial Intelligence, Yibin, Sichuan, China, Yibin (CN)

(21) Appl. No.: 17/898,493

(22) Filed: Nov. 22, 2022

(30) Foreign Application Priority Data
Aug. 30, 2021 (CN) 202111000396.6

(51) Int. Cl. G06Q 30/0282

(52) U.S. Cl. CPC G06Q 30/0282; G06N 3/0455; G06N 3/0985

(57) ABSTRACT

A recommendation method and system based on meta data augmentation relates to the field of personalized recommendation technologies. The method includes: training a cross-domain adaptive encoder-decoder model through user preference data; meta-augmentation ratings of a target domain user-item pair through a trained cross-domain adaptive encoder-decoder model; performing meta-learning training on a recommendation model; and recommending items to a user through a trained recommendation model. In the present disclosure, prior to the meta-learning training of the recommendation model, the cross-domain adaptive encoder-decoder model is trained through the user preference data, and data required for the meta-learning training of the recommendation model is meta-augmentation through the cross-domain adaptive encoder-decoder model, thereby effectively resolving a meta-overfitting problem in the existing meta-learning training of the recommendation model caused by the data sparsity and cold-start problem, and accurately recommending a user's preferred items to the user.

### CROSS REFERENCE TO THE RELATED APPLICATIONS

This application is based upon and claims priority to Chinese Patent Application No. 202111000396.6, filed on Aug. 30, 2021, the entire contents of which are incorporated herein by reference.

### TECHNICAL FIELD

The present disclosure relates to the field of personalized recommendation technologies, and in particular, to a recommendation method and system based on meta data augmentation.

### BACKGROUND

As one of the most critical and effective ways to alleviate information overload, the personalized recommendation technology plays a key role in various applications, such as online e-commerce websites Amazon, Netflix, and Yelp, and online education and news systems. Typically, a recommendation system recommends a personalized list of the most interesting items to a particular user.

Existing recommendation systems are mainly based on previous behavior interaction of the user, such as a purchase record, ratings, a click action, a watch record, and others, and therefore are referred to as collaborative filtering (CF) recommendation systems, which have been proved to be very successful. The CF recommendation systems include a user-based CF system that provides interesting, shared items for similar users and an item-based CF system that provides items with similar features for users. However, in practical applications, interaction matrices that represent user behavior interaction are often very sparse because most users have little or even no interaction with items. As a result, useful user preference cannot be effectively learned from limited interaction in the CF recommendation technology, thus resulting in poor performance.

Currently, the meta-learning method is mainly adopted to resolve the above problem in the scientific research field. The meta-learning method has a powerful generalization capability and can quickly adapt to new tasks having only a small number of samples. However, in the existing meta-learning recommendation methods, a non-exclusive task is directly constructed from real interaction data and leads to the critical meta-overfitting problem. Therefore, the performance of the existing recommendation method and system is not significantly improved in scenarios of sparse data and cold-start.

### SUMMARY

In view of the foregoing deficiencies in the prior art, the present disclosure provides a recommendation method and system based on meta data augmentation, to improve performance of the existing personalized recommendation technology in scenarios of sparse data and cold-start.

To achieve the foregoing objective of the present disclosure, the present disclosure adopts the following technical solutions:

According to a first aspect, a recommendation method based on meta data augmentation includes the following steps:
S1: training a cross-domain adaptive encoder-decoder model through user preference data;
S2: performing meta-augmentation on ratings of a target domain user-item pair through a trained cross-domain adaptive encoder-decoder model to obtain meta-augmentation ratings for user-item pairs of a target domain;
S3: constructing different tasks based on target domain user-items, target domain ratings and meta-augmentation ratings in the target domain, each task contains a support set and a query set, and performing meta-learning training on a recommendation model through the support set and the query set; and
S4: recommending items to a user through a trained recommendation model.

Beneficial effects of the present disclosure are as follows: Prior to the meta-learning training of the recommendation model, the cross-domain adaptive encoder-decoder model is trained through the user preference data, and data required for the meta-learning training of the recommendation model is meta-augmentation through the cross-domain adaptive encoder-decoder model, thereby effectively resolving a meta-overfitting problem in the existing meta-learning training of the recommendation model caused by the sparsity of user and item data and the poor capability to deal with cold-start, and accurately recommending a user's preferred items to the user.

Further, the user preference data in step S1 includes source domain user-item connection content, the target domain user-item connection content, ratings of a source domain user-item pair, and the ratings of the target domain user-item pair.

Further, the cross-domain adaptive encoder-decoder model includes a first source domain encoder, a second source domain encoder, a first target domain encoder, a second target domain encoder, a source domain decoder, and a target domain decoder.

Further, step S1 includes the following substeps:
S11: encoding the ratings of the source domain user-item pair through the first source domain encoder according to Gaussian distribution N(μₛ,Σₛ) to obtain a source domain user preference potential representation, where N( ) is a Gaussian distribution probability density function, μₛ is a source domain expectation, and Σₛ is a source domain variance;
S12: encoding the source domain user-item connection content through the second source domain encoder to obtain a source domain condition term;
S13: encoding the ratings of the target domain user-item pair through the first target domain encoder according to Gaussian distribution N(μₜ,Σₜ) to obtain a target domain user preference potential representation, where μₜ is a target domain expectation, and Σₜ is a target domain variance;
S14: encoding the target domain user-item connection content through the second target domain encoder to obtain a target domain condition term;
S15: reconstructing the ratings of the source domain user-item pair through the source domain decoder, and reconstructing the ratings of the target domain user-item pair through the target domain decoder; and
S16: training the cross-domain adaptive encoder-decoder model according to the user preference data, the source domain user preference potential representation, the source domain condition term, the target domain user preference potential representation, and the target domain condition term through a source domain loss function, a target domain loss function, an alternating optimization loss function, and a multi-view information bottleneck constraint object function.

Further, the source domain loss function in step S16 is:

$${L}_{S} ( {r}_{s} , {x}_{s} ; {θ}_{s} , {ϕ}_{s} ) = {E}_{{q}_{{ϕ}_{s}} ( {z}_{s} \vert {r}_{s} , {x}_{s} )} [ ln {p}_{{θ}_{s}} ( {r}_{s} \vert {z}_{s} , {c}_{s} ) ] - {D}_{KL} [ {q}_{{ϕ}_{s}} ( {z}_{s} \vert {r}_{s} , {x}_{s} ) \vert \vert p ( {z}_{s} ) ]$$

where, rₛ is the ratings of the source domain user-item pair, xₛ is the source domain user-item connection content, cₛ is the source domain condition term, θₛ is a parameter of the source domain decoder, φₛ is a parameter of the first source domain encoder, Lₛ(rₛ,xₛ;θₛ,φₛ) is the source domain loss function, p_{φ}_{ₛ}(zₛ|rₛ, xₛ) is a probability distribution function of the first source domain encoder, q_{θ}_{ₛ}(rₛ|zₛ,cₛ) is a probability distribution function of the source domain decoder, ln( ) is a natural logarithm function, zₛ is the source domain user preference potential representation, p(zₛ) is a probability of the source domain user preference potential representation,

$${E}_{{q}_{{ϕ}_{s}} ( {z}_{s} \vert {r}_{s} , {x}_{s} )} [ ln {p}_{{θ}_{s}} ( {r}_{s} \vert {z}_{s} , {c}_{s} ) ]$$

is a reconstruction error from the first source domain encoder to the source domain decoder, and D_{KL}[⋅∥⋅] is a Kullback-Leibler divergence function;
the target domain loss function in step S16 is:

$${L}_{T} ( {r}_{t} , {x}_{t} ; {θ}_{t} , {ϕ}_{t} ) = {E}_{{q}_{{ϕ}_{t}} ( {z}_{t} \vert {r}_{t} , {x}_{t} )} [ ln {p}_{{θ}_{t}} ( {r}_{t} \vert {z}_{t} , {c}_{t} ) ] - {D}_{KL} [ {q}_{{ϕ}_{t}} ( {z}_{t} \vert {r}_{t} , {x}_{t} ) \vert \vert p ( {z}_{t} ) ]$$

where, rₜ is the ratings of the target domain user-item pair, xₜ is the target domain user-item connection content, cₜ is the target domain condition term, θₜ is a parameter of the target domain decoder, φₜ is a parameter of the first target domain encoder, L_{T}(rₜ,xₜ;θₜ,φₜ) is the target domain loss function, q_{φ}_{ₜ}(zₜ/rₜ, xₜ) is a probability distribution function of the first target domain encoder, p_{θ}_{ₜ}(rₜ|zₜ,cₜ) is a probability distribution function of the target domain decoder, zₜ is the target domain user preference potential representation, p(zₜ) is a probability of the target domain user preference potential representation, and

$${E}_{{q}_{{ϕ}_{t}} ( {z}_{t} \vert {r}_{t} , {x}_{t} )} [ ln {p}_{{θ}_{t}} ( {r}_{t} \vert {z}_{t} , {c}_{t} ) ]$$

is a reconstruction error from the first target domain encoder to the target domain decoder;
the alternating optimization loss function in step S16 is:

$${L}_{X} = {‖ {z}_{s} - {q}_{{ϕ}_{{x}_{s}}} ( {c}_{s} \vert {x}_{s} ) ‖}^{2} + {‖ {z}_{t} - {q}_{{ϕ}_{{x}_{t}}} ( {c}_{t} \vert {x}_{t} ) ‖}^{2}$$

where, Lₓ is the alternating optimization loss function,

$${q}_{{ϕ}_{{x}_{s}}} ( {c}_{s} \vert {x}_{s} )$$

is a probability distribution function of the second source domain encoder

$$, {q}_{{ϕ}_{{x}_{t}}} ( {c}_{t} \vert {x}_{t} )$$

is a probability distribution function of the second target domain decoder, and ∥⋅∥² is a norm square function; and
the multi-view information bottleneck constraint object function in step S16 is:

$${L}_{MIB} ( {ϕ}_{s} , {ϕ}_{t} ) = - {I}_{{ϕ}_{s} , {ϕ}_{t}} ( {z}_{s ;} {z}_{t} ) + β {D}_{SKL} ( {q}_{{ϕ}_{s}} ( {z}_{s} \vert {r}_{s} , {x}_{s} ) ‖ {q}_{{ϕ}_{t}} ( {z}_{t} \vert {r}_{t} , {x}_{t} ) )$$

where, L_{MIB}(φₛ,φₜ) is the multi-view information bottleneck constraint object function, I_{φ}_{ₛ}_{,φ}_{ₜ}(zₛ,zₜ) is a mutual information function between the source domain user preference potential representation and the target domain user preference potential representation, β is a hyperparameter, and D_{SKL}[⋅∥⋅] is a symmetric Kullback-Leibler divergence function.

Beneficial effects of the foregoing further solution are as follows: The cross-domain adaptive encoder-decoder model including the first source domain encoder, the second source domain encoder, the first target domain encoder, the second target domain encoder, the source domain decoder, and the target domain decoder implements domain adaptation of user preferences across a source domain and a target domain through the substeps of foregoing step S1. Each loss function is based on prior conditional probability distribution, so that the cross-domain adaptive encoder-decoder model is trained through prior learning. As an effective information theory tool, a multi-view information bottleneck constraint can preserve shared information between a source domain and a target domain and discard non-shared information, thereby transferring user preferences from the source domain to the target domain and then building a basis for meta data augmentation.

Further, step S3 includes the following substeps:
S31: constructing different task samples of a training task set according to different target domain user-item connection contents and ratings of target domain user-item pairs corresponding to different target domain user-item connection contents;
S32: constructing different augmented task samples of the training task set according to different target domain user-item connection contents and meta-augmentation ratings of target domain user-item pairs corresponding to different target domain user-item connection contents;
S33: sampling the training task set to obtain different resampling tasks, and dividing each resampling task to obtain a support sample and a query sample;
S34: combining all support samples to form the support set, and combining all query samples to form the query set;
S35: performing inner circular meta-learning training on the recommendation model according to the support set; and
S36: performing outer circular meta-learning training on the recommendation model according to the query set to obtain the trained recommendation model.

Beneficial effects of the foregoing further solution are as follows: meta-augmentation information of a user shares the same user content as original information but has a different preference. Therefore, mutual exclusion is generated. Therefore, the constructed training task set including both a task sample and an augmented task sample is a training task set with mutually exclusive characters. Meta-learning training is performed based on the sampled support set and query set, to avoid an overfitting phenomenon of meta-learning, and therefore is more applicable to scenarios of cold-start and sparse data of the recommendation model.

According to a second aspect, a recommendation system based on meta data augmentation is provided, including a domain adaptation subsystem and a recommendation subsystem, where
the domain adaptation subsystem adopts the foregoing cross-domain adaptive encoder-decoder model to meta-augment ratings of a target domain user-item pair; and
the recommendation subsystem adopts the foregoing recommendation model to recommend an item to a user.

Further, the recommendation subsystem is a recommendation neural network including a link layer and a first layer to an M^{th} layer, where M is a positive integer greater than 3; the link layer is configured to link user content and item content;
the first layer to the (M−1)^{th} layer is configured to extract intermediate feature information; and
the M^{th} layer is configured to output a user-item recommendation result.

Beneficial effects of the foregoing further solution are as follows: A multi-layer neural network is used to perform collaborative filtering CF recommendation, so that a feature analysis capability of the multi-layer neural network is stronger than that of a neural network having only a link layer and an output layer, and recommendation performance is better.

According to a third aspect, a recommendation device based on meta data augmentation is provided, including a memory and a processor, where
the memory is configured to store a computer program; and
the processor is configured to execute the computer program to implement the steps of the foregoing recommendation method based on meta data augmentation.

According to a fourth aspect, a computer-readable storage medium is provided. The computer-readable storage medium stores a computer program, and when the computer program is executed by a processor, the steps of the foregoing recommendation method based on meta data augmentation are implemented.

### BRIEF DESCRIPTION OF THE DRAWINGS

FIG. 1 is a schematic flowchart of a recommendation method based on meta data augmentation according to an embodiment of the present disclosure.

FIG. 2 is a structural diagram of a recommendation system based on meta data augmentation according to an embodiment of the present disclosure.

FIG. 3 is a structural diagram of a recommendation device based on meta data augmentation according to an embodiment of the present disclosure.

### DETAILED DESCRIPTION OF THE EMBODIMENTS

The specific implementations of the present disclosure are described below to facilitate those skilled in the art to understand the present disclosure, but it should be clear that the present disclosure is not limited to the scope of the specific implementations. Various obvious changes made by those of ordinary skill in the art within the spirit and scope of the present disclosure defined by the appended claims should fall within the protection scope of the present disclosure.

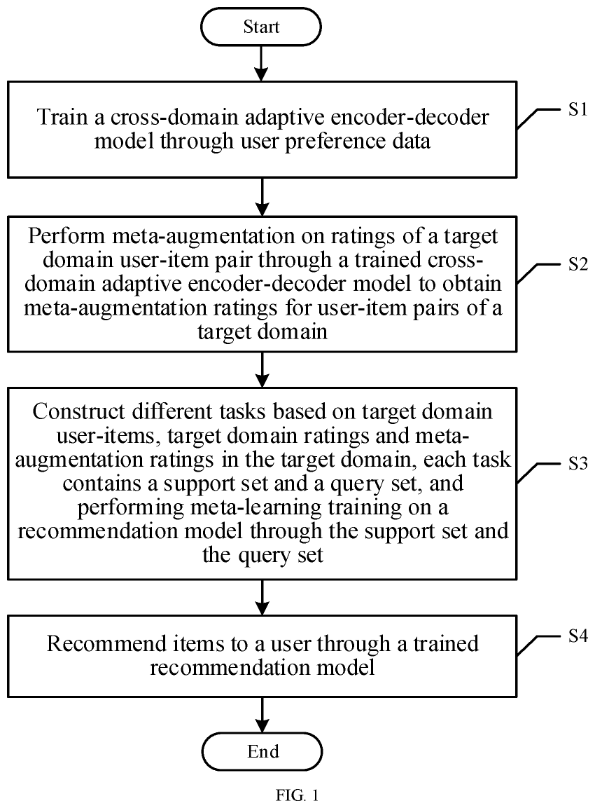

As shown in FIG. 1, in an embodiment of the present disclosure, a recommendation method based on meta data augmentation is provided, including the following steps:

S1: A cross-domain adaptive encoder-decoder model is trained through user preference data.

The user preference data includes source domain user-item connection content, the target domain user-item connection content, ratings of a source domain user-item pair, and the ratings of the target domain user-item pair.

A personalized recommendation technology is simply intended to recommend a user's preferred items to the user. Therefore, the user-item connection content described in the present disclosure is a generalized concept and is accompanying information of a pair relationship between a user and an item stored in a computer, and is ratings of the pair relationship between the user and the item stored in the computer.

The cross-domain adaptive encoder-decoder model includes a first source domain encoder, a second source domain encoder, a first target domain encoder, a second target domain encoder, a source domain decoder, and a target domain decoder.

Step S1 includes the following substeps:

S11: The ratings of the source domain user-item pair is encoded through the first source domain encoder according to Gaussian distribution N(μₛ,Σₛ) to obtain a source domain user preference potential representation, where N( ) is a Gaussian distribution probability density function, μₛ is a source domain expectation, and Σₛ is a source domain variance.

S12: The source domain user-item connection content is encoded through the second source domain encoder to obtain a source domain condition term.

S13: The ratings of the target domain user-item pair is encoded through the first target domain encoder according to Gaussian distribution N(μₜ,Σₜ) to obtain a target domain user preference potential representation, where μₜ is a target domain expectation, and Σₜ is a target domain variance.

S14: The target domain user-item connection content is encoded through the second target domain encoder to obtain a target domain condition term.

S15: The ratings of the source domain user-item pair is reconstructed through the source domain decoder and reconstruct the ratings of the target domain user-item pair through the target domain decoder.

S16: The cross-domain adaptive encoder-decoder model is trained according to the user preference data, the source domain user preference potential representation, the source domain condition term, the target domain user preference potential representation, and the target domain condition term through a source domain loss function, a target domain loss function, an alternating optimization loss function, and a multi-view information bottleneck constraint object function.

The source domain loss function is:

$${L}_{S} ( {r}_{s} , {x}_{s} ; {θ}_{s} , {ϕ}_{s} ) = {E}_{{q}_{{ϕ}_{s}} ( {z}_{s} \vert {r}_{s} , {x}_{s} )} [ ln {p}_{{θ}_{s}} ( {r}_{s} \vert {z}_{s} , {c}_{s} ) ] - {D}_{K L} [ {q}_{{ϕ}_{s}} ( {z}_{s} \vert {r}_{s} , {x}_{s} ) ‖ p ( {z}_{s} ) ]$$

where, rₛ is the ratings of the source domain user-item pair, xₛ is the source domain user-item connection content, cₛ is the source domain condition term, θₛ is a parameter of the source domain decoder, φₛ is a parameter of the first source domain encoder, Lₛ(rₛ,xₛ;θₛ,φₛ) is the source domain loss function, q_{φ}_{ₛ}(zₛ∥rₛ,xₛ) is a probability distribution function of the first source domain encoder, p_{θ}_{ₛ}(rₛ∥zₛ,cₛ) is a probability distribution function of the source domain decoder, ln( ) is a natural logarithm function, zₛ is the source domain user preference potential representation, p(zₛ) is a probability of the source domain user preference potential representation,

$${E}_{{q}_{{ϕ}_{s}} ( {z}_{s} \vert {r}_{s} , {x}_{s} )} [ ln {p}_{{θ}_{s}} ( {r}_{s} \vert {z}_{s} , {c}_{s} ) ]$$

is a reconstruction error from the first source domain encoder to the source domain decoder, D_{KL}[⋅∥⋅] and is a Kullback-Leibler divergence function:

$${D}_{K L} [ {q}_{{ϕ}_{s}} ( {z}_{s} \vert {r}_{s} , {x}_{s} ) ‖ p ( {z}_{s} ) ] = {q}_{{ϕ}_{s}} ( {z}_{s} \vert {r}_{s} , {x}_{s} ) \cdot \frac{{{q}_{ϕ}}_{s} ( {z}_{s} \vert {r}_{s} , {x}_{s} )}{p ( {z}_{s} )}$$

The target domain loss function is:

$${L}_{T} ( {r}_{t} , {x}_{t} ; {θ}_{t} , {ϕ}_{t} ) = {E}_{{q}_{{ϕ}_{t}} ( {z}_{t} \vert {r}_{t} , {x}_{t} )} [ ln {p}_{{θ}_{t}} ( {r}_{t} \vert {z}_{t} , {c}_{t} ) ] - {D}_{K L} [ {q}_{{ϕ}_{t}} ( {z}_{t} \vert {r}_{t} , {x}_{t} ) ‖ p ( {z}_{t} ) ]$$

where, rₜ is the ratings of the target domain user-item pair, xₜ is the target domain user-item connection content, cₜ is the target domain condition term, θₜ is a parameter of the target domain decoder, φₜ is a parameter of the first target domain encoder, L_{T}(rₜ,xₜ;θₜ, φₜ) is the target domain loss function, q_{φt}(zₜ∥rₜ,xₜ) is a probability distribution function of the first target domain encoder, p_{θ}_{ₜ}(rₜ|zₜ,cₜ) is a probability distribution function of the target domain decoder, zₜ is the target domain user preference potential representation, p(zₜ) is a probability of the target domain user preference potential representation, and

$${E}_{{q}_{{ϕ}_{t}} ( {z}_{t} \vert {r}_{t} , {x}_{t} )} [ ln {p}_{{θ}_{t}} ( {r}_{t} \vert {z}_{t} , {c}_{t} ) ]$$

is a reconstruction error from the first target domain encoder to the target domain decoder.

The alternating optimization loss function is:

$${L}_{X} = {‖ {z}_{s} - {q}_{{ϕ}_{{x}_{s}}} ( {c}_{s} \vert {x}_{s} ) ‖}^{2} + {‖ {z}_{t} - {q}_{{ϕ}_{{x}_{t}}} ( {c}_{t} \vert {x}_{t} ) ‖}^{2}$$

where, Lₓ is the alternating optimization loss function,

$${q}_{{ϕ}_{{x}_{s}}} ( {c}_{s} \vert {x}_{s} )$$

is a probability distribution function of the second source domain encoder,

$${q}_{{ϕ}_{{x}_{t}}} ( {c}_{t} \vert {x}_{t} )$$

is a probability distribution function of the second target domain decoder, and ∥⋅∥² is a norm square function.

The multi-view information bottleneck constraint object function is:

$${L}_{MIB} ( {ϕ}_{s} , {ϕ}_{t} ) = - {I}_{{ϕ}_{s} , {ϕ}_{t}} ( {z}_{s ;} {z}_{t} ) + β {D}_{SKL} ( {q}_{{ϕ}_{s}} ( {z}_{s} \vert {r}_{s} , {x}_{s} ) ‖ {q}_{{ϕ}_{t}} ( {z}_{t} \vert {r}_{t} , {x}_{t} ) )$$

where, L_{MIB}(φₛ,φₜ) is the multi-view information bottleneck constraint object function, I_{φ}_{ₛ}_{,φ}_{ₜ}(zₛ,zₜ) is a mutual information function between the source domain user preference potential representation and the target domain user preference potential representation, β is a hyperparameter, and D_{SKL}[⋅∥⋅] is a symmetric Kullback-Leibler divergence function. A calculation expression of the symmetric Kullback-Leibler divergence function is:

$${D}_{SKL} ( {q}_{{ϕ}_{s}} ( {z}_{s} \vert {r}_{s} , {x}_{s} ) ‖ {q}_{{ϕ}_{t}} ( {z}_{t} \vert {r}_{t} , {x}_{t} ) ) = \frac{1}{2} {D}_{KL} ( {q}_{{ϕ}_{s}} ( {z}_{s} \vert {r}_{s} , {x}_{s} ) ‖ {q}_{{ϕ}_{t}} ( {z}_{t} \vert {r}_{t} , {x}_{t} ) ) + \frac{1}{2} {D}_{KL} ( {q}_{{ϕ}_{t}} ( {z}_{t} \vert {r}_{t} , {x}_{t} ) ‖ {q}_{{ϕ}_{s}} ( {z}_{s} \vert {r}_{s} , {x}_{s} ) )$$

The cross-domain adaptive encoder-decoder model including the first source domain encoder, the second source domain encoder, the first target domain encoder, the second target domain encoder, the source domain decoder, and the target domain decoder implements domain adaptation of user preferences across a source domain and a target domain through the substeps of foregoing step S1. Each loss function is based on prior conditional probability distribution, so that the cross-domain adaptive encoder-decoder model is trained through prior learning. As an effective information theory tool, a multi-view information bottleneck constraint can preserve shared information between a source domain and a target domain and discard non-shared information, thereby transferring user preferences from the source domain to the target domain and then building a basis for meta data augmentation.

S2: Meta-augmentation is performed on ratings of a target domain user-item pair through a trained cross-domain adaptive encoder-decoder model to obtain meta-augmentation ratings for user-item pairs of a target domain.

In this embodiment of the present disclosure, a process of meta-augmentation the ratings of the target domain user-item pair is as follows: First, a new target domain user preference potential representation and a new target domain condition term are obtained through the trained cross-domain adaptive encoder-decoder model through the method processes in step S13 and step S14, and then the new target domain user preference potential representation is sampled through a target domain decoder and a probability distribution function p_{θ}_{ₜ}(rₜ|zₜ,cₜ) of the target domain decoder, to obtain the meta-augmentation ratings of the target domain user-item pair through decoding.

S3: A support set and a query set are constructed according to target domain user-item connection content, the ratings of the target domain user-item pair, and the meta-augmentation ratings of the target domain user-item pair, and meta-learning training is performed on a recommendation model through the support set and the query set.

Step S3 includes the following substeps:

S31: Different task samples of a training task set are constructed according to different target domain user-item connection contents and ratings of target domain user-item pairs corresponding to different target domain user-item connection contents.

In this embodiment, a task sample may be represented as T={(xₜ,rₜ)}.

S32: Different augmented task samples of the training task set are constructed according to different target domain user-item connection contents and meta-augmentation ratings of target domain user-item pairs corresponding to different target domain user-item connection contents.

In this embodiment, an augmented task sample may be represented as Tₐ={(xₜ, [symbol] )}, where [symbol] is the meta-augmentation ratings of the target domain user-item pair.

S33: The training task set is sampled to obtain different resampling tasks, and each resampling task is divided to obtain a support sample and a query sample.

In this embodiment of the present disclosure, the following formula is shown:

$${T}^{′} = \{ S , Q \} ,$$

where

T′ is a resampling task, S is a support sample, and Q is a query sample.

S34: All support samples are combined to form the support set, and all query samples are combined to form the query set.

S35: Inner circular meta-learning training is performed on the recommendation model according to the support set.

S36: Outer circular meta-learning training is performed on the recommendation model according to the query set to obtain the trained recommendation model.

Meta-augmentation information of a user shares the same user content as original information but has a different preference. Therefore, mutual exclusion is generated. Therefore, the constructed training task set including both a task sample and an augmented task sample is a training task set with mutually exclusive characters. Meta-learning training is performed based on the sampled support set and query set, to avoid an overfitting phenomenon of meta-learning, and therefore is more applicable to scenarios of cold-start and sparse data of the recommendation model.

Because methods for inner circular meta-learning training and outer circular meta-learning training belong to the prior art, details are not described in this embodiment of the present disclosure.

S4: An item is recommended to a user through a trained recommendation model.

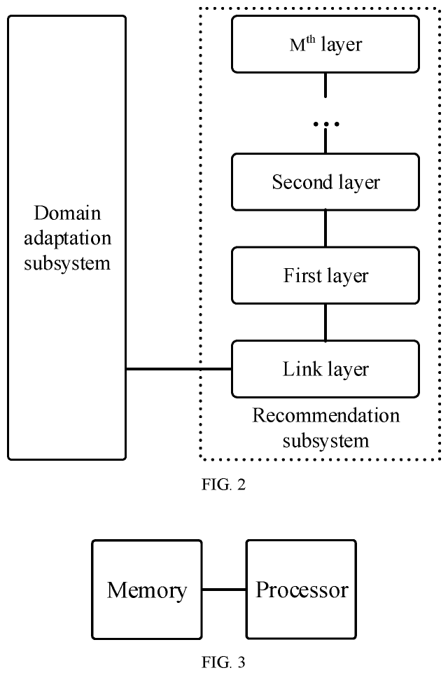

As shown in FIG. 2, an embodiment of the present disclosure provides a recommendation system based on meta data augmentation, including a domain adaptation subsystem and a recommendation subsystem, where

the domain adaptation subsystem adopts the foregoing cross-domain adaptive encoder-decoder model to meta-augment ratings of a target domain user-item pair; and

the recommendation subsystem adopts the foregoing recommendation model to recommend an item to a user, and the recommendation subsystem is a recommendation neural network including a link layer and a first layer to an M^{th} layer, where M is a positive integer greater than 3; the link layer is configured to link user content and item content; the first layer to the (M−1)^{th} layer are configured to extract intermediate feature information; and the M^{th} layer is configured to output a user-item recommendation result. A multi-layer neural network is used to perform collaborative filtering CF recommendation, so that a feature analysis capability of the multi-layer neural network is stronger than that of a neural network having only a link layer and an output layer, and recommendation performance is better.

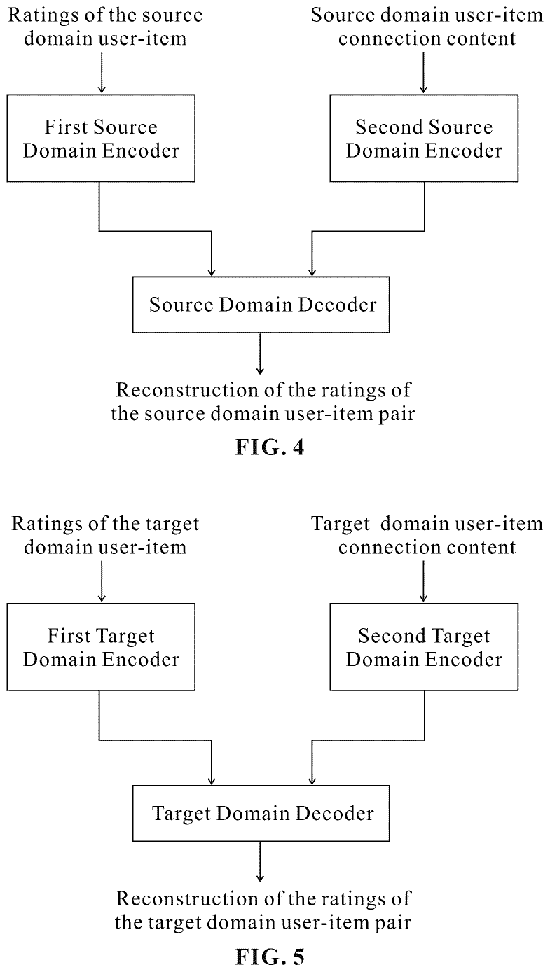

As shown in FIG. 3, an embodiment of the present disclosure provides a recommendation device based on meta data augmentation, including a memory and a processor. The memory is configured to store a computer program; and the processor is configured to execute the computer program to implement the steps of the foregoing recommendation method based on meta data augmentation.

An embodiment of the present disclosure further provides a computer-readable storage medium. The computer-readable storage medium stores a computer program, and when the computer program is executed by a processor, the steps of the foregoing recommendation method based on meta data augmentation are implemented.

In the embodiments of the present disclosure, a series of experiments are carried out to verify validity of the method and the system in the present disclosure. The proposed recommendation method and system based on meta data augmentation are compared with four existing technologies: (1) a cross-domain method, including a text-enhanced domain adaptation recommendation (TDAR) algorithm, a domain adaptation recommendation (DARec) algorithm, and an equivalent transformation learner (ETL); (2) a content perception method, including collaborative deep learning (CDL); (3) recommendation based on meta-learning, including a meta-learning user preference estimator (MeLU); and (4) a matrix factorization-based method (Neural collaborative filtering, NeuMF).

The performance of the embodiments of the present disclosure is evaluated based on Amazon datasets including user comments and metadata from an e-commerce website Amazon.com. The Amazon dataset covers user interaction with commodities (items described in the present disclosure) and commodity content of 24 product categories. In the embodiments of the present disclosure, four different categories are selected: Electronics, Movies, Music, and CD.

Electronics, Movies, and Music are selected as three source domains and CD is selected as a target domain to test cross-domain performance of the present disclosure for CD. The source domains and the target domain are then switched to test cross-domain performance for Electronics, Movies and Music. Six cross-domain datasets including Electronics-to-CD, CD-to-Electronics, Movies-to-CD, CD-to-Movies, Music-to-CD, and CD-to-Music are obtained. Then, in this embodiment, 99 negative commodity items that do not interact with the user and one positive commodity item are randomly sampled and ranked in the 100 commodity items. The performance is measured through a hit rate (HR), a mean reciprocal rank (MRR), and a normalized discounted cumulative gain (NDCG) commonly used in the field, and test results are shown in Table 1 and Table 2:

“MetaCAR” in Table 1 and Table 2 are English abbreviations in the embodiments of the present disclosure. It can be learned from Table 1 and Table 2 that the first 10 hit rates (HR@10), the first 10 mean reciprocal ranks (MRR@10), the first 10 normalized discounted cumulative gains (NDCG@10), the first 20 hit rates (HR@20), the first 20 mean reciprocal ranks (MRR@20), and the first 20 normalized discounted cumulative gains (NDCG@20) in the embodiments of the present disclosure are all greater than those in the remaining four existing technologies.

TABLE 1
Recommendation effect comparison table (I)

| Domain | Index | HR@10 | MRR@10 | NDCG@10 | HR@20 | MRR@20 | NDCG@20 |
|---|---|---|---|---|---|---|---|
| CDs | NeuMF | 0.1183 | 0.0410 | 0.0583 | 0.244 [symbol] | 0.0497 | 0.0002 |
| | MeLU | 0.1139 | 0.0282 | 0.0476 | 0.2518 | 0.0373 | 0.0819 |
| | CDL | 0.1183 | 0.0333 | 0.0527 | 0.2231 | 0.0404 | 0.07 [symbol] 0 |
| Electronics-to-CDs | TDAR | 0.1666 | 0.0488 | 0.0757 | 0.32 [symbol] 2 | 0.0597 | 0.1165 |
| | DARec | 0.1171 | 0.0315 | 0.05 [symbol] 0 | 0.2223 | 0.0386 | 0.0773 |
| | ETL | 0.1471 | 0.0431 | 0.0669 | 0.2869 | 0.0523 | 0.1017 |
| | MeLU-AUG | 0.1210 | 0.0330 | 0.0529 | 0.2579 | 0.0423 | 0.0873 |
| | MetaCAR | 0.2122 | 0.0665 | 0.1001 | 0.3425 | 0.0752 | 0.1327 |
| Movies-to-CDs | TDAR | 0.1658 | 0.0 [symbol] 79 | 0.0750 | 0.3151 | 0.0579 | 0.1123 |
| | DARec | 0.1320 | 0.0379 | 0. [symbol] 595 | 0.2512 | 0.0459 | 0.0894 |
| | ETL | 0.1552 | 0.0 [symbol] 63 | 0.0712 | 0.2817 | 0.0548 | 0.1028 |
| | MeLU-AUG | 0.1171 | 0.0324 | 0.0517 | 0.2489 | 0.0112 | 0.0846 |
| | MetaCAR | 0.2074 | 0.0689 | 0.1007 | 0.3557 | 0.0788 | 0.1378 |
| Music-to-CDs | TDAR | 0.1708 | 0.0 [symbol] 71 | 0.0757 | 0.3317 | 0.0582 | 0.1159 |
| | DARec | 0.133 [symbol] | 0.0417 | 0.0625 | 0.2456 | 0.0 [symbol] | 0.0904 |
| | ETL | 0.1711 | 0.0511 | 0.0787 | 0.2921 | 0. [symbol] 592 | 0.1089 |
| | MeLU-AUG | 0.1375 | 0. [symbol] 356 | 0.0587 | 0.2 [symbol] 19 | 0.0459 | 0.0971 |
| | MetaCAR | 0.2684 | 0.0832 | 0.1257 | 0.4364 | 0.0945 | 0.1678 |

[symbol]

indicates data missing or illegible when filed

TABLE 2
Recommendation effect comparison table (II)

| Domain | Index | HR@10 | MRR@10 | NDCG@10 | HR@20 | MRR@20 | NDCG@20 |
|---|---|---|---|---|---|---|---|
| Electronics | NeuMF | 0.1106 | 0.03 [symbol] 5 | 0.0519 | 0.229 [symbol] | 0. [symbol] 26 | 0.0818 |
| | MELU | 0.1314 | 0.0728 | 0.0863 | 0.2022 | 0.0774 | 0.1038 |
| | CDL | 0.1230 | 0.0394 | 0.058 [symbol] | 0.2270 | 0.0466 | 0.0 [symbol] 51 |
| CDs-to-Electronics | TDAR | 0.1 [symbol] 8 [symbol] | 0.0567 | 0.0825 | 0.2941 | 0.065 [symbol] | 0.11 [symbol] 8 |
| | DArec | 0.146 [symbol] | 0.046 | 0.0 [symbol] 1 | 0.2301 | 0.0517 | 0.0 [symbol] 01 |
| | ETL | 0.13 [symbol] | 0.04 [symbol] 4 | 0.0 [symbol] 8 | 0.2471 | 0. [symbol] 527 | 0.09 [symbol] |
| | MeLU-AUG | 0.1065 | 0.1059 | 0.1060 | 0.1207 | 0.1067 | 0.10 [symbol] |
| | MetaCAR | 0.1964 | 0.1115 | 0.1307 | 0.3130 | 0.1195 | 0.1601 |
| Movies | NeuMF | 0.1159 | 0.0351 | 0.0 [symbol] | 0.21 [symbol] 5 | 0.0 [symbol] 2 [symbol] | 0.07 [symbol] |
| | MELU | 0.1 [symbol] 31 | 0.07 [symbol] 8 | 0.1048 | 0.363 [symbol] | 0.0904 | 0.1476 |
| | CDL | 0.1604 | 0.0583 | 0.0 [symbol] | 0.2 [symbol] 71 | 0.0648 | 0. [symbol] |
| CDs-to-Movies | TDAR | 0.12 [symbol] | 0.0931 | 0.1 [symbol] 4 | 0.1405 | 0. [symbol] 3 | 0.1045 |
| | DArec | 0.177 [symbol] | 0.0576 | 0.0 [symbol] 1 | 0.2 [symbol] 61 | 0. [symbol] 7 | 0.11 [symbol] |
| | ETL | 0.1 [symbol] 93 | 0. [symbol] 01 | 0.0832 | 0.2 [symbol] 7 | 0.0 [symbol] | 0.1071 |
| | MeLU-AUG | 0.1 [symbol] 17 | 0.07 [symbol] 6 | 0.1018 | 0.3 [symbol] 8 | 0.0 [symbol] | 0.1413 |
| | MetaCAR | 0.2463 | 0.0864 | 0.1234 | 0.3878 | 0.0961 | 0.1590 |
| Music | NeuMF | 0.1708 | 0.062 [symbol] | 0.0880 | 0.2667 | 0.0597 | 0.1041 |
| | MELU | 0.1868 | 0.0527 | 0.0 [symbol] 2 | 0.2872 | 0.05 [symbol] 6 | 0.108 [symbol] |
| | CDL | 0.1094 | 0.0292 | 0.0475 | 0.2521 | 0.0.0391 | 0.0 [symbol] 37 |
| CDs-to-Music | TDAR | 0.1516 | 0.0 [symbol] 65 | 0.0628 | 0.2611 | 0.0439 | 0.0 [symbol] 2 |
| | DArec | 0.2142 | 0.0 [symbol] 32 | 0.0981 | 0.27 [symbol] 4 | 0.0674 | 0.1137 |
| | ETL | 0.1310 | 0.03 [symbol] 0 | 0.05 [symbol] | 0.23 [symbol] | 0. [symbol] 418 | 0.0818 |
| | MeLU-AUG | 0.1215 | 0.0727 | 0.0841 | 0.2 [symbol] 81 | 0.0826 | 0.1212 |
| | MetaCAR | 0.2333 | 0.1036 | 0.1322 | 0.2 [symbol] 55 | 0.1074 | 0.1473 |

[symbol]

indicates data missing or illegible when filed

In view of the above, in the present disclosure, prior to the meta-learning training of the CF recommendation model, the cross-domain adaptive encoder-decoder model is trained through the user preference data, and data required for the meta-learning training of the CF recommendation model is meta-augmentation through the cross-domain adaptive encoder-decoder model, thereby effectively resolving a meta-overfitting problem in the existing meta-learning training of the CF recommendation model caused by the sparsity of user and item data and the poor capability to deal with cold-start, and accurately recommending a user's preferred items to the user.

The present disclosure is described with reference to the flowcharts and/or block diagrams of the method, the device (system), and the computer program product according to the embodiments of the present disclosure. The computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, such that the instructions executed by a computer or a processor of another programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, such that a series of operations and steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

In this specification, specific embodiments are used to describe the principle and implementations of the present disclosure, and the description of the embodiments is only intended to help understand the method and core idea of the present disclosure. Meanwhile, a person of ordinary skill in the art may, based on the idea of the present disclosure, make modifications with respect to the specific implementations and the application scope. Therefore, the content of this specification shall not be construed as a limitation to the present disclosure.

Those of ordinary skill in the art will understand that the embodiments described herein are intended to help readers understand the principles of the present disclosure, and the protection scope of the present disclosure is not limited to such special statements and embodiments. Those of ordinary skill in the art may make other various specific modifications and combinations according to the technical teachings disclosed in the present disclosure without departing from the essence of the present disclosure, and such modifications and combinations still fall within the protection scope of the present disclosure.

1-20. (canceled)

21. A computer-implemented method for generating recommendations based on meta data augmentation, the method being performed by a specifically programmed computing device comprising a processor and a memory, the method comprising:
S1: receiving, by the computing device, user preference data comprising source domain user-item connection content, target domain user-item connection content, ratings of a source domain user-item pair, and ratings of a target domain user-item pair; and training, by the computing device, a cross-domain adaptive encoder-decoder model using the user preference data, wherein the cross-domain adaptive encoder-decoder model comprises:
a first source domain encoder configured to receive ratings of the source domain user-item pair and output a source domain user preference potential representation,
a second source domain encoder configured to receive source domain user-item connection content and output a source domain condition term,
a first target domain encoder configured to receive ratings of the target domain user-item pair and output a target domain user preference potential representation,
a second target domain encoder configured to receive target domain user-item connection content and output a target domain condition term,
a source domain decoder configured to receive as input the outputs of the first source domain encoder and the second source domain encoder and reconstruct the ratings of the source domain user-item pair,
a target domain decoder configured to receive as input the outputs of the first target domain encoder and the second target domain encoder and reconstruct the ratings of the target domain user-item pair,
wherein the encoders and decoders are implemented as neural network modules within the computing device, and the data flow between the encoders and decoders is explicitly defined as above,
wherein step S1 comprises the following substeps:
S11: encoding the ratings of the source domain user-item pair through the first source domain encoder according to Gaussian distribution N(μₛ,Σₛ) to obtain a source domain user preference potential representation, wherein N( ) is a Gaussian distribution probability density function, μₛ is a source domain expectation, and Σₛ is a source domain variance, and outputting the source domain user preference potential representation to the source domain decoder;
S12: encoding the source domain user-item connection content through the second source domain encoder to obtain a source domain condition term, and outputting the source domain condition term to the source domain decoder;
S13: encoding the ratings of the target domain user-item pair through the first target domain encoder according to Gaussian distribution N(μₜ,Σₜ) to obtain a target domain user preference potential representation, wherein μₜ is a target domain expectation, and Σₜ is a target domain variance, and outputting the target domain user preference potential representation to the target domain decoder;
S14: encoding the target domain user-item connection content through the second target domain encoder to obtain a target domain condition term, and outputting the target domain condition term to the target domain decoder;
S15: reconstructing, by the source domain decoder, the ratings of the source domain user-item pair using the outputs of the first and second source domain encoders, and reconstructing, by the target domain decoder, the ratings of the target domain user-item pair using the outputs of the first and second target domain encoders; and
S16: optimizing the cross-domain adaptive encoder-decoder model by the computing device using a source domain loss function, a target domain loss function, an alternating optimization loss function, and a multi-view information bottleneck constraint object function, each implemented as a neural network loss function executed by the computing device,
wherein the multi-view information bottleneck constraint object function is configured to maximize the mutual information between the source domain user preference potential representation and the target domain user preference potential representation while minimizing non-shared information, thereby improving cross-domain adaptation,
wherein the alternating optimization loss function is configured to minimize the squared norm between the user preference potential representations and the condition terms for both source and target domains,
wherein the above steps are performed by the computing device in a non-generic technical manner to improve recommendation accuracy in sparse data and cold-start scenarios;
S2: generating, by the computing device, meta-augmentation ratings for user-item pairs of the target domain by inputting target domain user-item connection content and ratings into the trained cross-domain adaptive encoder-decoder model, and outputting meta-augmentation ratings;
S3: constructing, by the computing device, a plurality of meta-learning tasks based on the target domain user-items, target domain ratings, and meta-augmentation ratings, each task comprising a support set and a query set, and performing meta-learning training on a recommendation model using the support set and the query set, wherein the meta-learning training is performed by the computing device to enable rapid adaptation to new users or items; and
S4: outputting, by the computing device, a recommendation of one or more items to a user based on the trained recommendation model, wherein the recommendation is generated by executing the trained model on the computing device.

22. The method of claim 21, wherein the step of constructing meta-learning tasks (S3) further comprises:
S31: constructing, by the computing device, a plurality of task samples for a training task set, each task sample corresponding to a unique target domain user-item connection content and its associated rating,
S32: constructing, by the computing device, a plurality of augmented task samples for the training task set, each augmented task sample corresponding to a unique target domain user-item connection content and its associated meta-augmentation rating,
S33: sampling, by the computing device, the training task set to obtain a plurality of resampling tasks, and dividing each resampling task into a support sample and a query sample,
S34: combining, by the computing device, all support samples to form a support set, and all query samples to form a query set,
S35: and performing, by the computing device, inner-loop meta-learning training on the recommendation model using the support set, and
S36: performing, by the computing device, outer-loop meta-learning training on the recommendation model using the query set to obtain the trained recommendation model.

23. A computer system comprising:
a domain adaptation subsystem implemented by a processor and memory, the subsystem configured to perform the method of claim 21, including meta-augmentation of ratings using the cross-domain adaptive encoder-decoder model, and
a recommendation subsystem implemented by the processor and memory, the subsystem configured to execute the trained recommendation model to recommend items to users,
wherein the system is specifically programmed to perform the steps of claim 21 in a non-generic, technical manner.

24. The system of claim 23, wherein the recommendation subsystem comprises a neural network including:
a link layer configured to combine user content and item content,
at least three hidden layers configured to extract intermediate feature information,
an output layer configured to output a user-item recommendation result,
wherein the neural network is implemented by the processor and memory of the system.

25. A non-transitory computer-readable storage medium storing instructions that, when executed by a processor, cause the processor to perform the method of claim 21.

26. The computer-readable storage medium of claim 25, wherein the instructions, when executed, cause the processor to perform the following steps:
S1: receiving, by the computing device, user preference data comprising source domain user-item connection content, target domain user-item connection content, ratings of a source domain user-item pair, and ratings of a target domain user-item pair; and training, by the computing device, a cross-domain adaptive encoder-decoder model using the user preference data, wherein the cross-domain adaptive encoder-decoder model comprises:
a first source domain encoder configured to receive ratings of the source domain user-item pair and output a source domain user preference potential representation,
a second source domain encoder configured to receive source domain user-item connection content and output a source domain condition term,
a first target domain encoder configured to receive ratings of the target domain user-item pair and output a target domain user preference potential representation,
a second target domain encoder configured to receive target domain user-item connection content and output a target domain condition term,
a source domain decoder configured to receive as input the outputs of the first source domain encoder and the second source domain encoder and reconstruct the ratings of the source domain user-item pair,
a target domain decoder configured to receive as input the outputs of the first target domain encoder and the second target domain encoder and reconstruct the ratings of the target domain user-item pair,
wherein the encoders and decoders are implemented as neural network modules within the computing device, and the data flow between the encoders and decoders is explicitly defined as above,
wherein step S1 comprises the following substeps:
S11: encoding the ratings of the source domain user-item pair through the first source domain encoder according to Gaussian distribution N(μₛ,Σₛ) to obtain a source domain user preference potential representation, wherein N( ) is a Gaussian distribution probability density function, μₛ is a source domain expectation, and Σₛ is a source domain variance, and outputting the source domain user preference potential representation to the source domain decoder;
S12: encoding the source domain user-item connection content through the second source domain encoder to obtain a source domain condition term, and outputting the source domain condition term to the source domain decoder;
S13: encoding the ratings of the target domain user-item pair through the first target domain encoder according to Gaussian distribution N(μₜ,Σₜ) to obtain a target domain user preference potential representation, wherein μₜ is a target domain expectation, and Σₜ is a target domain variance, and outputting the target domain user preference potential representation to the target domain decoder;
S14: encoding the target domain user-item connection content through the second target domain encoder to obtain a target domain condition term, and outputting the target domain condition term to the target domain decoder;
S15: reconstructing, by the source domain decoder, the ratings of the source domain user-item pair using the outputs of the first and second source domain encoders;
reconstructing, by the target domain decoder, the ratings of the target domain user-item pair using the outputs of the first and second target domain encoders;
S16: optimizing the cross-domain adaptive encoder-decoder model by the computing device using a source domain loss function, a target domain loss function, an alternating optimization loss function, and a multi-view information bottleneck constraint object function, each implemented as a neural network loss function executed by the computing device, wherein the multi-view information bottleneck constraint object function is configured to maximize the mutual information between the source domain user preference potential representation and the target domain user preference potential representation while minimizing non-shared information, thereby improving cross-domain adaptation,
wherein the alternating optimization loss function is configured to minimize the squared norm between the user preference potential representations and the condition terms for both source and target domains,
wherein the above steps are performed by the computing device in a non-generic, technical manner to improve recommendation accuracy in sparse data and cold-start scenarios,
S2: generating, by the computing device, meta-augmentation ratings for user-item pairs of the target domain by inputting target domain user-item connection content and ratings into the trained cross-domain adaptive encoder-decoder model, and outputting meta-augmentation ratings;
S3; constructing, by the computing device, a plurality of meta-learning tasks based on the target domain user-items, target domain ratings, and meta-augmentation ratings, each task comprising a support set and a query set, and performing meta-learning training on a recommendation model using the support set and the query set, wherein the meta-learning training is performed by the computing device to enable rapid adaptation to new users or items;
S4: outputting, by the computing device, a recommendation of one or more items to a user based on the trained recommendation model, wherein the recommendation is generated by executing the trained model on the computing device.

27. The system of claim 23, wherein the step of constructing meta-learning tasks (S3) further comprises:
S31: constructing, by the computing device, a plurality of task samples for a training task set, each task sample corresponding to a unique target domain user-item connection content and its associated rating,
S32: constructing, by the computing device, a plurality of augmented task samples for the training task set, each augmented task sample corresponding to a unique target domain user-item connection content and its associated meta-augmentation rating,
S33: sampling, by the computing device, the training task set to obtain a plurality of resampling tasks, and dividing each resampling task into a support sample and a query sample,
S34: combining, by the computing device, all support samples to form a support set, and all query samples to form a query set,
S35: and performing, by the computing device, inner-loop meta-learning training on the recommendation model using the support set,
S36: performing, by the computing device, outer-loop meta-learning training on the recommendation model using the query set to obtain the trained recommendation model.

28. The device of claim 25, wherein the instructions, when executed, cause the processor to perform the following steps for constructing meta-learning tasks (S3):
S31: constructing, by the processor, a plurality of task samples for a training task set, each task sample corresponding to a unique target domain user-item connection content and its associated rating,
S32: constructing, by the processor, a plurality of augmented task samples for the training task set, each augmented task sample corresponding to a unique target domain user-item connection content and its associated meta-augmentation rating,
S33: sampling, by the processor, the training task set to obtain a plurality of resampling tasks, and dividing each resampling task into a support sample and a query sample,
S34: combining, by the processor, all support samples to form a support set, and all query samples to form a query set,
S35: and performing, by the processor, inner-loop meta-learning training on the recommendation model using the support set,
S36: performing, by the processor, outer-loop meta-learning training on the recommendation model using the query set to obtain the trained recommendation model.

29. The computer-readable storage medium of claim 26, wherein the instructions, when executed, cause the processor to perform the following steps for constructing meta-learning tasks (S3):
S31: constructing, by the processor, a plurality of task samples for a training task set, each task sample corresponding to a unique target domain user-item connection content and its associated rating,
S32: constructing, by the processor, a plurality of augmented task samples for the training task set, each augmented task sample corresponding to a unique target domain user-item connection content and its associated meta-augmentation rating,
S33: sampling, by the processor, the training task set to obtain a plurality of resampling tasks, and dividing each resampling task into a support sample and a query sample,
S34: combining, by the processor, all support samples to form a support set, and all query samples to form a query set,
S35: performing, by the processor, inner-loop meta-learning training on the recommendation model using the support set,
S36: performing, by the processor, outer-loop meta-learning training on the recommendation model using the query set to obtain the trained recommendation model.
